(19) United States
(12) Patent Application Publication
(10) Pub. No.: US 2007/0066722 A1
(43) Pub. Date: Mar. 22, 2007

(54) Thermoplastic composites containing lignocellulosic materials and methods of making the same

(75) Inventors: Shane R.C. O'Neill, Old Town, ME (US); Douglas J. Gardner, Brewer, ME (US); Stephen M. Shaler, Veazie, ME (US)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: University of Maine System Board of Trustees

(21) Appl. No.: 11/228,668

(22) Filed: Sep. 16, 2005

(51) Int. Cl. C08L 1/00; C08G 18/38

(52) U.S. Cl. 524/35

(57) ABSTRACT

A thermoplastic composite includes stabilized raw lignocellulosic materials dispersed in a thermoplastic polymeric matrix. A method for stabilizing the raw lignocellulosic materials in a matrix includes at least one of: a) pre-melting of a thermoplastic polymeric material prior to combining with the raw lignocellulosic materials; b) reducing the melt temperature of the polymeric material; c) increasing the surface compatibilization of the raw lignocellulosic materials; d) thermally stabilizing the lignocellulosic material; and, e) any combinations of a) through d).

### TECHNICAL FIELD

This invention relates to processes to stabilize lignocellulosic materials in thermoplastic composites and to such composites containing stabilized lignocellulosic materials.

### BACKGROUND OF THE INVENTION

Various industries are looking at additive materials to improve the properties of thermoplastics. In particular, there is a need to improve the properties of extruded plastics at competitive prices, while conserving materials and shortening process times. For example, in the past U.S. Pat. No. 5,948,524 to Seethamraju et al. describes combining wood and polymer together, then heating the mixture to melt the polymer.

A common problem is the expense of using pure material, both in terms of the environmental costs and the economic costs of producing thermoplastic composites. U.S. Pat. Nos. 6,270,883 and 6,730,249 to Sears et al. describe thermoplastic composites using high purity and expensive cellulose (where the cellulose is the most thermally stable constituent in wood).

### SUMMARY OF THE INVENTION

In one aspect, the present invention provides a composite comprising stabilized raw lignocellulosic materials dispersed in a thermoplastic polymeric matrix.

In another aspect, the present invention relates to a composite having a thermoplastic polymeric matrix and stabilized lignocellulosic materials. In certain embodiments, the raw lignocellulosic materials and a stabilizer are mixed together, then blended with the thermoplastic polymeric material. The stabilizer materials are selected from at least one of: metallic and glycerol soaps, organotin compounds, organo-phosphites, thiosynergistic antioxidants, hindered phenolic antioxidants, carbon black, and hindered amine stabilizers (HAS), and combinations thereof.

In another aspect, the present invention relates to a raw lignocellulosic thermoplastic polymeric composite further including least one compatibilizing agent, such as, titanates, zirconates, silanates, maleic anhydride and mixtures thereof.

In yet another aspect, the present invention relates to a composite granule for injection molding comprising stabilized raw lignocellulosic materials dispersed in a matrix of a thermoplastic material.

In still another aspect, the present invention relates to an injection molded product of a fiber-reinforced thermoplastic material comprising stabilized raw lignocellulosic materials dispersed in a matrix of a thermoplastic material.

Yet another aspect of the present invention relates to a method for stabilizing raw lignocellulosic materials in a matrix comprising: at least one of the following: pre-melting of a thermoplastic polymeric material prior to combining with the raw lignocellulosic materials; reducing the polymeric melt temperature; increasing surface compatibilization of the raw lignocellulosic materials; thermal stabilizing the lignocellulosic material; and combinations thereof.

In another aspect, the reinforcement system also provides superior performance for wood composites, and in particular, for use in structural applications.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a schematic illustration of a method for forming a thermoplastic composite containing stabilized lignocellulosic materials.

### DETAILED DESCRIPTION OF THE INVENTION

In one aspect, the present invention relates to composites containing raw, stabilized lignocellulosic materials dispersed in a matrix. In certain embodiments, the matrix comprises a thermoplastic polymeric material and the stabilized lignocellulosic materials.

The present invention uses one or more unique methods to stabilize the raw lignocellulosic materials. The present invention thus allows for the use of raw lignocellulosic materials as a whole, which results in reduced material costs; i.e., currently raw lignocellulosic materials cost about $0.10/lb, while cellulose costs about $1.10/lb.

The raw lignocellulosic materials are generally defined herein as lignocellulosic material from a plant-based source that has been reduced in size through mechanical actions only. The lignocellulosic material itself has only been reduced in size.

The lignocellulosic materials useful in the invention are considered to be in a “raw” state, meaning there has been no chemical modification of the lignocellulosic materials.

In one embodiment, the composite contains the stabilized lignocellulosic materials dispersed in a matrix. The matrix comprises at least one thermoplastic polymeric material and lignocellulosic materials which may or may not been pre-treated or coated with any materials such as homopolymers, copolymers, random copolymers, alternating copolymers, block copolymers, graft copolymers, liquid crystal polymers, or mixtures thereof.

Also, the overall concentrations of such lignocellulosic components as cellulose, hemicellulose, lignin and extractives in the lignocellulosic materials remain relatively unchanged. The lignin and hemicellulose components found in the “raw” lignocellulosic materials greatly differ from cellulose since the lignin and hemicellulose components are not nearly as thermally stable as the cellulose component.

Preferably, the lignocellulosic materials are substantially dispersed throughout the composite. In certain embodiments, the amount of raw lignocellulosic material used is preferably between about 20 to about 60%, by weight, and in certain embodiments between about 25 to 55%, by weight, in the composite.

In certain other embodiments, the amount of lignocellulosic material used is about 60% or less, by weight; in other embodiments, about 40% or less, by weight; and in still other embodiments, about 25% or less, by weight, in the composite.

The lignocellulosic material may be derived from a softwood or hardwood source, as well as other types of agricultural fibers (including but not limited to: corn, wheat, jute, hemp, flax, bamboo, coconut, kenaf, and sisal) or mixtures thereof. Lignin is a polymer having monomeric units of phenylpropanes. Normal softwoods contain from about 26 to about 32% lignin while hardwoods contain from about 20 to about 25% lignin. In addition, the lignin type is slightly different between hardwoods and softwoods. Also, softwoods primarily contain trans-coniferyl alcohol, while hardwoods primarily contain trans-sinapyl alcohol.

In certain embodiments, the lignocellulosic materials are in a particle form. These particles are generated using either milling or granulating technologies, where the lignocellulosic material is broken down in size through mechanical particle reduction. Typically, a small amount of frictional heat is imparted into the process. However, this is not used to reduce the bulk constituents of the lignocellulosic material further. The milled lignocellulosic materials typically have an average length between 0.1 (#140 mesh) and 5 mm (#4 mesh). In certain embodiments, the lignocellulosic materials are in the form of loose fibers, granulated fibers, mechanically milled particles, or pelletized fibers.

In certain embodiments, the water content of the raw lignocellulosic material ranges from about 1 to about 8% by weight Moisture Content (MC). According to the present invention, there is no need for a moisture reduction step for the lignocellulosic materials. In contrast, the conventional extrusion technology requires that less than about 2% MC, by weight, in cellulose based material for the conventional extrusion technology to work.

In another aspect of the present invention, the stabilization of the raw lignocellulosic materials includes a thermal stabilization agent to deter thermal degradation of the lignocellulosic materials at elevated temperatures. The raw lignocellulosic materials are pre-compounded with a thermal stabilization agent before being dispersed in a matrix with a thermoplastic material. In certain embodiments, the lignocellulosic stabilization agent includes, for example, metallic and glycerol soaps, organotin compounds (including but not limited to mercaptides, maleates, and carboxylates), organo-phosphites, thiosynergistic antioxidants, hindered phenolic antioxidants, carbon black, and Hindered amine stabilizers (HAS), and combinations thereof. Preferably, the stabilization agents are substantially mixed with the raw lignocellulosic materials and then dispersed throughout the thermoplastic matrix. In certain embodiments, the amount of stabilization material used is preferably between about 3 to about 10%, by weight, and in certain embodiments between about 4 to 9%, by weight, in the composite.

In another aspect of the present invention, the lignocellulosic materials are stabilized by premelting of the thermoplastic material prior to mixing with the lignocellulosic materials. The composite is formed by introducing the raw lignocellulosic material and the polymer together where the polymer is in a molten form. In certain embodiments, the amount of thermoplastic material used is preferably between about 35 to about 85%, by weight, and in certain embodiments between about 40 to 75%, by weight, in the composite.

According to one embodiment, the polymeric material is a thermoplastic having a melting point of about 180° C. or greater; in other embodiments about 200° C. or greater; and in still other embodiments, between about 220 to about 250° C.

In certain embodiments, the polymeric material is a thermoplastic selected from nylon 6, nylon 12, nylon 66 or mixtures thereof.

In certain other embodiments, the polymeric material has a melting point preferably between about 180 to about 270° C. Suitable polymeric materials include polyamides (nylon and polycaprolactam), PET (polyethylene terephthalate), PBT (polybutylene terephthalate), or mixtures thereof. Other suitable materials include PTT (polytrimethylterephthalate), ECM (ethylene-carbon monoxide) and styrene copolymer blends such as styrene/acrylonitrile (SAN) and styrene/maleic anhydride (SMA) thermoplastic polymers. Still further materials include polyacetals, cellulose butyrate, ABS (acrylonitrile-butadiene-styrene), methyl methacrylates, and polychlorotrifluoroethylene polymers.

In another aspect of the present invention, the lignocellulosic materials are stabilized by introducing a process additive that reduces the thermoplastic melt temperature. Such examples of these include (but are not limited to) Ziegler-Natta based catalysts, inorganic salts (such as LiBr, LiCl), metallocene, benzenesulfonamides, styrene-acrylic acid copolymers, diglycidyl ether of bisphenol A (DGEBA).

In another aspect of the present invention, the lignocellulosic materials are stabilized by including a process additive that increases surface compatibilization of the lignocellulosic materials. In certain embodiments, the composite further comprises at least one coupling, grafting, or compatibilizing, agent. The compatibilizing agent is selected from the group of titanates, zirconates, silanates, maleic anhydride or mixtures thereof. The compatibilizing agent is present in an amount less than 5% by weight; and, in certain embodiments, the coupling or compatibilizing agent is present in an amount less than 3% by weight. Also, in certain embodiments, the composite further includes at least one suitable colorant material, such as titanium dioxide, carbon black and the like.

In another aspect, the present invention relates to improved composite materials containing stabilized lignocellulosic materials as a reinforcing material therein.

The use of such lignocellulosic materials provides improved structural characteristics to the composite at a reduced cost and with only a modest increase in the density of the composite material.

Also, the use of such lignocellulosic materials also does not significantly abrade the processing equipment.

In another aspect, the present invention relates to a method for the stabilization of the lignocellulosic materials that prevents and/or minimizes the generation of malodors and unacceptable discoloration of the composite material.

Additionally, the use of the lignocellulosic materials according to the invention allows for the blending of the components and the shaping of the resultant composite materials at lower processing temperatures. Surprisingly, the composite materials may be injection molded using processing temperatures below those used with conventional composites, even below the melting point of the pure polymeric matrix material itself.

In another aspect, the present invention includes a composite granule for injection molding composed of fiber-reinforced thermoplastic materials comprising a multiplicity of stabilized lignocellulosic materials dispersed in a matrix of thermoplastic material, where said lignocellulosic materials have not been pre-treated or coated.

In another aspect, the present invention includes an injection molded product of a fiber-reinforced thermoplastic material comprising a multiplicity of stabilized lignocellulosic materials dispersed in a matrix of the thermoplastic material, where said lignocellulosic materials have not been coated with a graft copolymer.

### EXAMPLES

The following examples are illustrative of some of the products and methods of making the same falling within the scope of the present invention. They are, of course, not to be considered in any way limitative of the invention. Numerous changes and modifications can be made with respect to the invention by one of ordinary skill in the art.

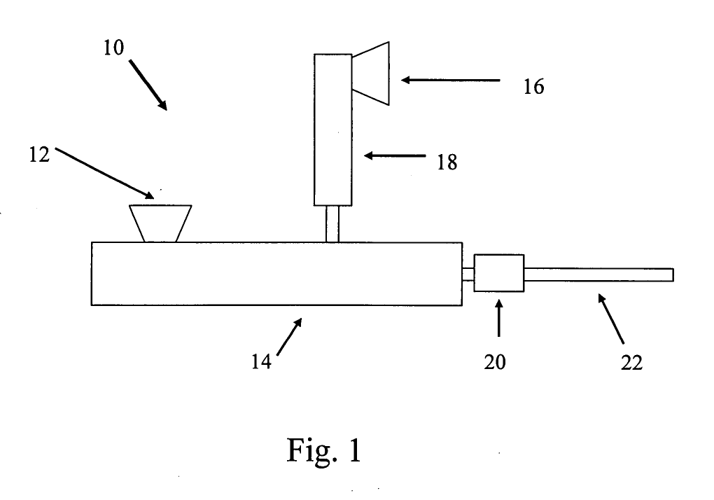

Referring now to FIG. 1, a schematic illustration of one method 10 is shown where the raw lignocellulosic materials, stabilizers (and optional lubricants) 12 are pre-mixed, then added to a compounding extruder. Thermoplastic materials (and optionally pigments and additives) 16 are heated in a melt extruder 18, then added to the compounding extruder 14. The compounding extruder 14 mixes together the melted thermoplastic material and the stabilized raw lignocellulosic materials to form a matrix. The matrix can then be sent to a die 20 for further processing as an extrudate 22.

Processing

Extrusion processing runs were conducted on a Davis-Standard® WT-94 Woodtruder™. This particular system consists of a GP94 94 mm counter-rotating parallel twin-screw extruder (28:1 L/D) coupled with a Mark V™ 75 mm single screw extruder. The feed system consists of three (3) Colortronics gravimetric feeders supplying the 75 mm single screw extruder via flood feeding and three (3) Colortronics gravimetric feeders supplying the 94 mm twin screw extruder via starvation feeding. Decking material was extruded in a profile measuring 20 mm×135 mm (0.75″×5.375″). The wood utilized was 40 mesh sawdust from American Wood Fiber (#4020BB). This wood is a commercially available wood furnish that has only been mechanically reduced in size from larger constituents. The polymer used was a commercially available nylon 6-6,6 from BASF (#Ultramid C35 NAT). The stabilizing agent used in this example was zinc stearate (Synpro #6723032109944). In this example, a total of eight formulations were manufactured. The processing parameters for each formulation are summarized in Table 1.

Mechanical Properties

The eight formulations were examined for both flexural (bending) and tensile properties. Flexural testing was conducted in accordance with ASTM D 6109. (D6 109-05 Standard Test Methods for Flexural Properties of Unreinforced and Reinforced Plastic Lumber and Related Products). The modulus of rupture (MOR) and modulus of elasticity (MOE) of the material is listed. Tensile testing was conducted in accordance with ASTM D 638, Type III. ( D638-03 Standard Test Method for Tensile Properties of Plastics). The tensile strength of the material is listed.

TABLE 1
Processing Parameters During Manufacture of Nylon-WPC

| | Processing | Formulation # | | | | | | | |
|---|---|---|---|---|---|---|---|---|---|
| | Variables | 1 | 2 | 3 | 4 | 5 | 6 | 7 | 8 |
| RATIO | Wood | 25% | 35% | 45% | 43% | 50% | 55% | 44% | 29% |
| | Stabilizer | 4% | 4% | 4% | 7% | 6% | 5% | 7% | 9% |
| | Polymer | 71% | 61% | 51% | 50% | 44% | 40% | 49% | 63% |
| TWIN | Melt | 189 | 189 | 189 | 188 | 190 | 191 | 190 | 191 |
| SCREW | Temperature | | | | | | | | |
| | (° C.) | | | | | | | | |
| | Pressure | 375 | 425 | 500 | 375 | 400 | 700 | 275 | 115 |
| | (lb/in²) | | | | | | | | |
| | Screw speed | 30 | 30 | 30 | 30 | 30 | 30 | 30 | 30 |
| | (RPM) | | | | | | | | |
| | Torque | 22% | 23% | 24% | 25% | 30% | 42% | 23% | 13% |
| | Load | | | | | | | | |
| SINGLE | Melt | 220 | 220 | 220 | 220 | 220 | 219 | 219 | 219 |
| SCREW | Temperature | | | | | | | | |
| | (° C.) | | | | | | | | |
| | Pressure | 1,200 | 1,200 | 1,200 | 1,200 | 1,200 | 1,200 | 1,200 | 1,150 |
| | (lb/in²) | | | | | | | | |
| | Screw speed | 40 | 40 | 40 | 40 | 40 | 40 | 40 | 40 |
| | (RPM) | | | | | | | | |
| | Torque | 68% | 68% | 68% | 68% | 68% | 68% | 68% | 67% |
| | Load | | | | | | | | |

TABLE 2
Mechanical Properties of Nylon-WPC

| Mechanical | Formulation # | | | | | | | |
|---|---|---|---|---|---|---|---|---|
| Property | 1 | 2 | 3 | 4 | 5 | 6 | 7 | 8 |
| MOR (ksi) | 8.4 | 12.9 | 12.0 | 10.3 | 9.9 | 7.0 | 9.0 | 9.0 |
| TMOE (ksi) | 360 | 665 | 885 | 707 | 687 | 586 | 611 | 435 |
| Tensile | 8.0 | 4.6 | 4.3 | 4.9 | 4.4 | 2.3 | 4.2 | 4.9 |
| Strength | | | | | | | | |
| (ksi) | | | | | | | | |

Note:
MOR and TMOE determined in accordance with ASTM D 6109
Tensile Strength determined in accordance with ASTM D 638

While the invention has been described with reference to various embodiments, it should be understood by those skilled in the art that various changes may be made and equivalents may be substituted for elements thereof without departing from the essential scope of the invention. In addition, many modifications may be made to adapt a particular situation or material to the teachings of the invention without departing from the essential scope thereof. Therefore, it is intended that the invention not be limited to the particular embodiment disclosed herein contemplated for carrying out this invention, but that the invention will include all embodiments falling within the scope of the claims.

What is claimed is:

1. A composite comprising stabilized raw lignocellulosic materials dispersed in a thermoplastic polymeric matrix.

2. The composite of claim 1, wherein the stabilized lignocellulosic materials comprise: raw lignocellulosic materials and a stabilizer selected from at least one of: metallic and glycerol soaps, organotin compounds, organo-phosphites, thiosynergistic antioxidants, hindered phenolic antioxidants, carbon black, and hindered amine stabilizers (HAS), and combinations thereof.

3. The composite of claim 1, wherein the composite comprises about 60% or less, by weight, raw lignocellulosic materials.

4. The composite of claim 1, wherein the composite comprises about 40% or less, by weight, raw lignocellulosic materials.

5. The composite of claim 1, wherein the composite comprises about 25% or less, by weight, raw lignocellulosic materials.

6. The composite of claim 1, wherein the raw lignocellulosic materials comprise loose fibers, granulated fibers, mechanically milled particles, or pelletized fibers and combinations thereof.

7. The composite of claim 1, wherein the amount of water in the raw lignocellulosic materials is in an amount of about 1 to about 8%, by weight.

8. The composite of claim 1, further comprising at least one compatibilizing agent.

9. The composite of claim 8, wherein the compatibilizing agent comprises titanates, zirconates, silanates, maleic anhydride and mixtures thereof.

10. The composite of claim 8, wherein the compatibilizing agent is present in an amount of about 5% or less, by weight.

11. The composite of claim 8, wherein the compatibilizing agent is present in an amount of about 3% or less, by weight.

12. The composite of claim 1, wherein the thermoplastic material has a melting point of about 180° C. or higher.

13. The composite of claim 1, wherein the polymeric material comprises a thermoplastic material having a melting temperature in the range of about 180 to about 270° C.

14. The composite of claim 13, wherein the thermoplastic material comprises: polyamides (nylon and polycaprolactam), PET (polyethylene terephthalate), PBT (polybutylene terephthalate), PTT (polytrimethylene terephthalate), ECM (ethylene-carbon monoxide), SAM (styrene/acrylonitrile), SMA (stylene/maleic anhydride) or mixtures thereof.

15. The composite of claim 14, wherein the polymeric material comprises: polyamides, including Nylon 6, Nylon 12, Nylon 66 or mixtures thereof.

16. The composite of claim 1, wherein the thermoplastic polymeric material is present in an amount of about 75% or less, by weight.

17. The composite of claim 1, wherein the thermoplastic polymeric material is present in an amount of about 50% or less, by weight.

18. The composite of claim 12, wherein the thermoplastic polymeric material is present in an amount of about 40% or less, by weight.

19. The composite of claim 1, further comprising at least one colorant.

20. A composite granule for injection molding comprising the composite of claim 1.

21. An injection molded product of a fiber-reinforced thermoplastic material comprising the composite of claim 1.

22. A method for stabilizing raw lignocellulosic materials in a thermoplastic polymeric matrix comprising at least one of:
a) pre-melting of a polymeric material prior to combining with the raw lignocellulosic materials,
b) reducing the melt temperature of the polymeric material,
c) increasing surface compatibilization of the raw lignocellulosic materials,
d) thermally stabilizing the raw lignocellulosic materials, and
e) any combinations of a) through d).

23. The method of claim 22, wherein the stabilized lignocellulosic materials comprise raw lignocellulosic materials and a stabilizer selected from at least one of: metallic and glycerol soaps, organotin compounds, organo-phosphites, thiosynergistic antioxidants, hindered phenolic antioxidants, carbon black, and hindered amine stabilizers (HAS), and combinations thereof.

24. The method of claim 22, wherein the composite comprises about 60% or less, by weight, raw lignocellulosic materials.

25. The method of claim 22, wherein the composite comprises about 40% or less, by weight, raw lignocellulosic materials.

26. The method of claim 22, wherein the composite comprises about 25% or less, by weight, raw lignocellulosic materials.

27. The method of claim 25, wherein the raw lignocellulosic materials comprise loose fibers, granulated fibers, mechanically milled particles, or pelletized fibers and combinations thereof.

28. The method of claim 22, wherein the amount of water in the raw lignocellulosic materials is in an amount of about 1 to about 8%, by weight.

29. The method of claim 22, further comprising at least one compatibilizing agent.

30. The method of claim 29, wherein the compatibilizing agent comprises titanates, zirconates, silanates, maleic anhydride and mixtures thereof.

31. The method of claim 29, wherein the compatibilizing agent is present in an amount of about 5% or less, by weight.

32. The method of claim 29, wherein the compatibilizing agent is present in an amount of about 3% or less, by weight.

33. The method of claim 22, wherein the thermoplastic polymeric material comprises a thermoplastic material having a melting temperature in the range of about 180 to about 270° C.

34. The method of claim 33, wherein the thermoplastic material comprises: polyamides (nylon and polycaprolactam), PET (polyethylene terephthalate), PBT (polybutylene terephthalate), PTT (polytrimethylene terephthalate), ECM (ethylene-carbon monoxide), SAM (styrene/acrylonitrile), SMA (styrene/maleic anhydride) or mixtures thereof.

35. The method of claim 34, wherein the polymeric material comprises: polyamides, including Nylon 6, Nylon 12, Nylon 66 or mixtures thereof.

36. The method of claim 22, wherein the thermoplastic polymeric material is present in an amount of about 75% or less, by weight.

37. The method of claim 22, wherein the thermoplastic polymeric material is present in an amount of about 50% or less, by weight.

38. The method of claim 22, wherein the thermoplastic polymeric material is present in an amount of about 40% or less, by weight.

39. The method of claim 22, further comprising at least one colorant.

40. A composite granule for injection molding comprising stabilized raw lignocellulosic materials dispersed in a matrix of a thermoplastic material formed by the method of claim 22.

41. An injection molded product of a fiber-reinforced thermoplastic material comprising stabilized raw lignocellulosic materials dispersed in a matrix of a thermoplastic material formed by the method of claim 22.
